(19) United States
(12) Patent Application Publication
(10) Pub. No.: US 2020/0271091 A1
(43) Pub. Date: Aug. 27, 2020

(54) WIND MASTER

(71) Applicant: David L. Pitcher, Sacramento, CA (US)

(72) Inventor: David L. Pitcher, Sacramento, CA (US)

(21) Appl. No.: 16/282,260

(22) Filed: Feb. 21, 2019

(51) Int. Cl. F03D 3/04; F03D 1/04

(52) U.S. Cl. CPC F03D 3/0427; F05B 2240/133; F03D 1/04

(57) ABSTRACT

A wind tunnel system increasing wind flow into and out of a wind turbine is presented. T the wind tunnel system has a wind turbine. The wind turbine converts kinetic energy from wind to electrical energy. The wind tunnel system has a wind inception system that has a netting, a pole and a skin. The wind inception center is useful for increasing wind to the wind turbine. The wind tunnel system further has a wind disperser. The wind disperser receives outputted wind from the wind turbine and disperses the received outputted wind from the wind turbine.

### FIELD OF THE INVENTION

This invention relates to wind turbines. More particularly, it relates to providing wind to wind turbines.

### BACKGROUND

Wind generation systems have received much interest as an alternative to fossil fuels plants. Wind generation systems have the disadvantage of providing fluctuating or intermittent power output due to the variability of wind speed. Additionally, there is a finite ramp up and ramp down (decay) function from individual wind turbines when wind speeds change. The decay function is generally of the order of several minutes. Models of short-term fluctuations are well advanced, and variations can be predicted with high levels of confidence. Combining such models with physical turbine inertias, the power outputs from wind turbines is predictable and can be included in power system planning as a dispatchable resource.

There remains a limit to how much capacity credit can be given to an individual wind turbine. This is particularly true where the wind regimen is not coincident with load demand. For example, in certain wind turbine farm locations, wind speeds are greatest when the system demand is lowest. Prices for wind energy and capacity will always, therefore, be discounted at a short run avoided cost rate unless there is very high confidence that load demand and wind turbine output overlap.

A solution to variable output from wind turbines is to provide storage for the excess energy. The energy may then be delivered to a grid when the wind turbine output drops off. From the supply side perspective, this is an availability enhancement tool to provide a spinning reserve and a firm source of supply. From the demand side perspective, the storage is a load shaping or leveling tool. New electrical storage technologies are able to provide fast response to load fluctuations and large scale shifting of energy from off-peak or low value time periods to peak periods.

Integrating an energy storage system and a wind-based generator in either a single wind turbine form or in a group of turbines involves the selection of a capacity and storage duration which allows the output to be firmed up in an optimal fashion. If the cost of this energy storage system is such that the added benefits resulting from its installation including increased energy sales (less spillage), increased capacity payments, and ancillary service benefits amount to more than its operating and repayment costs, then the energy storage system becomes a viable option. In addition, the energy storage system improves the penetration levels of wind power generation and improves system parameters, such as power quality, voltage control, and overall load factor. By applying energy storage at distribution levels, localized benefits as well as summated transmission system benefits occur.

Thus, it would be an advancement in the art to provide a stable and constant wind input to produce a constant power output from one or more wind turbine generators by employing the benefits of an energy storage system.

### BRIEF DESCRIPTION OF THE DRAWINGS

FIG. 1 is an illustrated side view of an exemplary wind funnel system.

FIG. 2 is an illustrated top view of the exemplary wind funnel system of FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

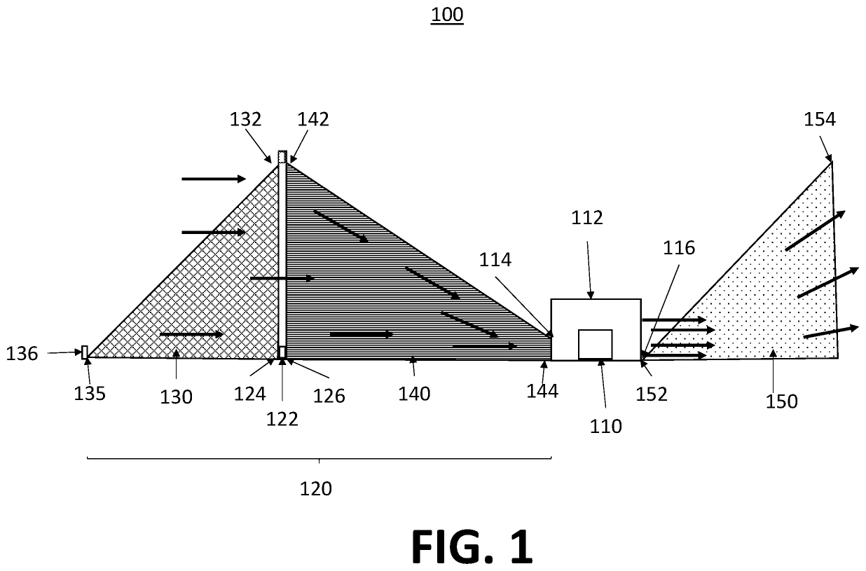

Referring to FIG. 1, a side view of an exemplary wind tunnel system 100 is illustrated. The wind tunnel system 100 is useful for directing the wind, regardless of wind speed, to a wind turbine to generate electricity. The wind tunnel system 100 further filters the air from large debris, birds, etc. to prevent damage to the wind vanes of the wind turbine. Direction of the wind is indicated by the arrows flowing into and out of the wind tunnel system 100.

The wind tunnel system 100 has a wind turbine 110, a sound shield 112, a wind inception system 120 and a wind disperser 150.

The wind turbine 110 converts the kinetic energy of wind into electrical energy. The wind turbine 110 is preferably a tower with one or more wind vanes which rotate and provide the conversion of the kinetic energy to the electrical energy. The wind turbine 110 may be any other type of wind energy conversion device. The wind turbine 110 preferably has a sound shield 112 which mutes the sound or hum of the wind turbine 110 when the wind turbine 110 is in operation.

The wind turbine 110 has an intake side 114 and an output side 116. The intake side 114 of the wind turbine 110 receives wind into the wind turbine 110 and after the kinetic energy of the wind has been converted into electrical energy, the wind is dispersed at the output side 116.

The wind turbine 110 is coupled to the wind reception system 120 at the intake side 114 of the wind turbine 110. The wind reception system 120 has a netting 130, a pole 122, and a skin 140. The wind reception system 120 is useful for receiving the wind and directing the wind from multiple altitudes to the ground to be received by the wind turbine 110. The wind inception center 120 is sized to the size of the wind turbine, thus is adaptable to the size of the wind turbine.

The netting 130 is useful for trapping and removing large particles in the air, birds, etc. from the wind as the wind is being directed to the skin 140. The netting 130 is preferably triangular in shape, but may be any shape. The netting 130 has a long side 132 and an extended point 135. The netting 130 is preferably made of a net or mesh material but may be any material which allows wind to pass through it but removes larger particles and birds from the passed through wind.

The long end 132 of the netting 130 is coupled to the pole 122 at a first side 124. The extended point 135 of the netting 130 is coupled to a stake 136. The stake 136 may be a stake or any unmovable object. The stake 136 may be a metal such as steel, iron, aluminum, or any other type of material that may not be metal.

The pole 122 may be a tower, a rod, a pole, etc. The pole 122 may be made of a hard, durable and strong material such as steel, iron, aluminum, hard plastic, etc. The pole 122 further has a second side 126.

The skin 140 has a long side 142 and an output side 144. The skin 140 may be any material such as plastic, cloth, leather, steel, etc. The skin 140 is useful for directing the wind received through the netting 130 and directing the wind down towards the wind turbine 110. The skin 140 is preferably triangular in shape, but may be any shape.

The long side 142 of the skin 140 is coupled to the second side 126 of the pole 122. The coupling of the long side 142 of the skin 140 to the second side 126 of the pole 122 may be any coupling means by which the long skin 140 is securely coupled to the second side 126 of the pole 122. The wind is received at the long side 142 of the skin 140 and directed to the output side 144 of the skin 140.

The output side 144 of the skin 140 directs the wind into the intake side 114 of the wind turbine 110 of the wind tunnel system 100. The wind turbine 110 receives the wind from the output side 144 of the skin 140 and converts the kinetic energy of the wind into electrical energy.

The energy converted from the wind, but the wind is the expelled from the wind turbine at the output side 116 of the wind turbine 110. The wind disperser 150 of the wind tunnel system 100 is useful in expelling the wind back to the atmosphere while dispersing the wind such that the power of the wind is reduced from the power of the wind received at the wind disperser 150.

The wind disperser 150 of the wind tunnel system 100 has an input side 152 and an output side 150. The input side 152 of the wind disperser 150 is coupled to the output side 116 of the wind turbine 110. The wind disperser 150 is preferably triangular in shape, but may be any shape one of ordinary skill in the art may choose.

The wind outputted by the wind turbine 110 at the output side 116 is received at the input side 152 of the wind disperser 150 and is directed upward and dispersed to a greater area at the output side 154 of the wind disperser 150 to reduce the power level and velocity of the wind. The input side 152 of the wind disperser 150 is substantially smaller than the output side 154 of the wind disperser thereby allowing the wind to be dispersed into a much greater area.

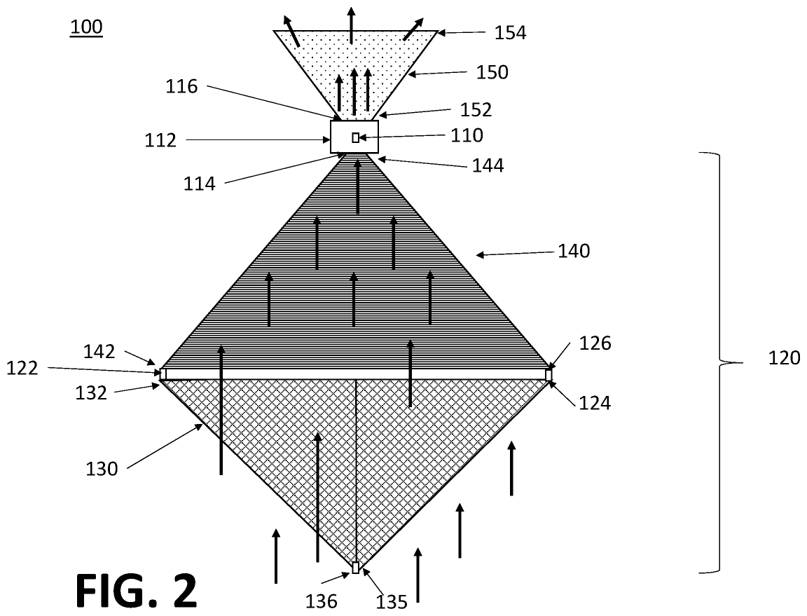

Referring now to FIG. 2, a top view of the wind tunnel system 100 is illustrated.

The wind tunnel system 100 has a wind turbine 110, a sound shield 112, a wind inception system 120 and a wind disperser 150.

The wind turbine 110 converts the kinetic energy of wind into electrical energy. The wind turbine 110 is preferably a tower with one or more wind vanes which rotate and provide the conversion of the kinetic energy to the electrical energy. The wind turbine 110 may be any other type of wind energy conversion device. The wind turbine 110 preferably has a sound shield 112 which mutes the sound or hum of the wind turbine 110 when the wind turbine 110 is in operation.

The wind turbine 110 has an intake side 114 and an output side 116. The intake side 114 of the wind turbine 110 receives wind into the wind turbine 110 and after the kinetic energy of the wind has been converted into electrical energy, the wind is dispersed at the output side 116.

The wind turbine 110 is coupled to the wind reception system 120 at the intake side 114 of the wind turbine 110. The wind reception system 120 has a netting 130, a pole 122, and a skin 140. The wind reception system 120 is useful for receiving the wind and directing the wind from multiple altitudes to the ground to be received by the wind turbine 110.

The netting 130 is useful for trapping and removing large particles in the air, birds, etc. from the wind as the wind is being directed to the skin 140. The netting 130 is preferably triangular in shape, but may be any shape. The netting 130 has a long side 132 and an extended point 135. The netting 130 is preferably made of a net or mesh material but may be any material which allows wind to pass through it but removes larger particles and birds from the passed through wind.

The long end 132 of the netting 130 is coupled to the pole 122 at a first side 124. The extended point 135 of the netting 130 is coupled to a stake 136. The stake 136 may be a stake or any unmovable object. The stake 136 may be a metal such as steel, iron, aluminum, or any other type of material that may not be metal.

The pole 122 may be a tower, a rod, a pole, etc. The pole 122 may be made of a hard, durable and strong material such as steel, iron, aluminum, hard plastic, etc. The pole 122 further has a second side 126.

The skin 140 has a long side 142 and an output side 144. The skin 140 may be any material such as plastic, cloth, leather, steel, etc. The skin 140 is useful for directing the wind received through the netting 130 and directing the wind down towards the wind turbine 110. The skin 140 is preferably triangular in shape, but may be any shape.

The long side 142 of the skin 140 is coupled to the second side 126 of the pole 122. The coupling of the long side 142 of the skin 140 to the second side 126 of the pole 122 may be any coupling means by which the long skin 140 is securely coupled to the second side 126 of the pole 122. The wind is received at the long side 142 of the skin 140 and directed to the output side 144 of the skin 140.

The output side 144 of the skin 140 directs the wind into the intake side 114 of the wind turbine 110 of the wind tunnel system 100. The wind turbine 110 receives the wind from the output side 144 of the skin 140 and converts the kinetic energy of the wind into electrical energy.

The energy converted from the wind, but the wind is the expelled from the wind turbine at the output side 116 of the wind turbine 110. The wind disperser 150 of the wind tunnel system 100 is useful in expelling the wind back to the atmosphere while dispersing the wind such that the power of the wind is reduced from the power of the wind received at the wind disperser 150.

The wind disperser 150 of the wind tunnel system 100 has an input side 152 and an output side 150. The input side 152 of the wind disperser 150 is coupled to the output side 116 of the wind turbine 110. The wind disperser 150 is preferably triangular in shape, but may be any shape one of ordinary skill in the art may choose.

The wind outputted by the wind turbine 110 at the output side 116 is received at the input side 152 of the wind disperser 150 and is directed upward and dispersed to a greater area at the output side 154 of the wind disperser 150 to reduce the power level and velocity of the wind. The input side 152 of the wind disperser 150 is substantially smaller than the output side 154 of the wind disperser thereby allowing the wind to be dispersed into a much greater area.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A wind tunnel system for improving wind flow into a wind turbine, the wind tunnel system comprising:
a wind turbine, wherein the wind turbine converts kinetic energy from wind to electrical energy;
a wind inception system, wherein the wind inception center having a netting, a pole and a skin, the wind inception center for increasing wind to the wind turbine; and
a wind disperser, the wind disperser receiving outputted wind from the wind turbine and dispersing the received wind.

2. The wind tunnel system of claim 1 wherein the netting of the wind inception center being a triangular shape.

3. The wind tunnel system of claim 1, wherein the skin of the wind inception center being a triangular shape.

4. The wind tunnel system of claim 1, wherein the wind dispenser being a triangular shape.

5. The wind tunnel system of claim 1, further comprising:
a stake, wherein the stake is coupled to an extended point of the netting of the wind tunnel system.

6. The wind tunnel system of claim 1, further comprising:
a first end of the skin is coupled to a first side of the pole; and
the second end of the skin is coupled to an intake side of the wind turbine.

7. The wind tunnel system of claim 1, further comprising:
an output end of the wind turbine being coupled to an input side of the wind dispenser; and
the wind received at the input side of the wind dispenser being dispensed at the output side of the wind dispenser.

8. The wind tunnel system of claim 1, wherein the netting being for removing debris from the wind.

9. The wind tunnel system of claim 1, wherein the netting being a mesh material.

10. The wind tunnel system of claim 1, wherein the netting being a net material.

11. The wind tunnel system of claim 1, wherein the skin being a plastic material.

12. The wind tunnel system of claim 1, wherein the skin being a leather material.

13. The wind tunnel system of claim 1, wherein the wind inception system being size adaptable to a size of the wind turbine.

14. The wind tunnel system of claim 1, wherein the wind dispenser being a plastic material.

15. The wind tunnel system of claim 1, wherein the input side of the wind dispenser is substantially smaller than the output side of the wind dispenser.

16. The wind tunnel system of claim 1, wherein an extended point of the netting being substantially smaller than a long end of the netting.

17. The wind tunnel system of claim 1, wherein a long end of the skin is substantially larger than an output side of the skin.
